(19) United States
(12) Patent Application Publication
(10) Pub. No.: US 2011/0024484 A1
(43) Pub. Date: Feb. 3, 2011

(54) VAPOR PHASE REWORK STATION AND METHOD

(75) Inventors: David Suihkonen, Burnsville, MN (US); Ray Willett, Burnsville, MN (US)

Correspondence Address: PATENT DEPARTMENT;LARKIN, HOFFMAN, DALY & LINDGREN, LTD., 1500 WELLS FARGO PLAZA, 7900 XERXES AVENUE SOUTH, BLOOMINGTON, MN, 55431, US

(73) Assignee: Vapor Works, Inc., Burnsville, MN (US)

(21) Appl. No.: 12/933,718

(22) PCT Filed: Mar. 24, 2009
(86) PCT No.: PCT/US09/38091

§ 371 Date: Sep. 21, 2010

Related U.S. Application Data
(60) Provisional application No. 61/039,004, filed on Mar. 24, 2008.

(51) Int. Cl. B23K 1/018

(52) U.S. Cl. 228/264

(57) ABSTRACT

A vapor phase rework station and methods for reworking a circuit board to remove and replace components soldered thereto. A nozzle is disposed over the target component and vapor is communicated from a vapor source to the interior volume of the nozzle. As the vapor heats the solder holding the target component to the circuit board, the vapor condenses within the interior volume. The condensed vapor is suctioned from the interior volume of the nozzle. A component gripping tool grips the target component and withdraws it from the circuit board. The reverse operation is performed to reflow the solder to attach a new component to the circuit board in the area from which the target component was previously removed.

### BACKGROUND

If a printed circuit board has a damaged or inoperative electrical component, rather than discarding the entire circuit board, the circuit board is typically “reworked” to remove the damaged components and replace it with a new component. In order to remove the component from the circuit board, the solder securing the component must be heated to a temperature sufficiently high to melt the solder without damaging the circuit board or other adjacent electronic components.

Conventional rework stations use a variety of methods for heating the solder, including hot air, infrared heating, hot plates or lasers. Various problems may be experienced with these forms of heating, including, for example, overheating or poor uniformity of heating due to shadowing, deflection or reflection, which may cause or result in cold solder joints and stress damage to the printed board or the surrounding electronic components.

Vapor phase heating or heating by condensation of a vapor is a much more reliable and uniform method of heat transfer. Vapor phase or condensation heating is well known and is used extensively for reflow soldering processes for attaching surface mounted components to circuit boards. Vapor phase heating uses an inert liquid that, when heated, will begin to boil at precise known temperature which will produce a vapor that is a very stable and uniform heat transfer medium. The inert heated vapor is able to quickly and efficiently transfer heat by evenly enveloping all the surfaces exposed to the vapor. As the vapor comes in contact with the cooler surfaces it condenses upon those surfaces transferring heat as it condenses. Because the vapor completely envelopes all the surfaces, uniform temperature throughout the exposed area is assured such that there is no uneven heating, shadowing or deflection of the heat process. Thus, because the temperature of the vapor is precise, uniform and stable, vapor phase heating will eliminates the concern of overheating and it avoids the problems associated with other heating methods. Different inert liquids having different boiling or vapor temperatures may be selected depending on the properties of the solder and the components being used. For example, an inert liquid having a known maximum vapor temperature may be selected that is just minimally higher than the melting point of the solder being used. The inert liquids currently on the market used for reflow applications have boiling point temperatures from 180° C. to 320° C.

Despite the known advantages and extensive use of vapor phase for reflow applications, heretofore, no one has devised a commercially successful apparatus or system that utilizes vapor phase heating for rework applications. While others have attempted to devise such systems, such as disclosed in European Patent No. EP450329, and in United States Patent Nos. U.S. Pat. No 4,194,297 and U.S. Pat. No. 4,561,586, these prior attempts have not met with commercial success.

### DESCRIPTION OF THE DRAWINGS

FIG. 1 is a schematic diagram for an embodiment of a vapor phase rework station.

FIG. 2 is an enlarged view of the nozzle area illustrated in FIG. 1.

FIG. 3 is a perspective view of a preferred embodiment of a vapor phase rework station.

FIG. 4 is a front elevation view of the vapor phase rework station of FIG. 3.

FIG. 5 is an enlarged perspective view of the vapor phase rework station of FIG. 3.

FIG. 6 is a perspective view of the rework head of the vapor phase rework station of FIG. 3.

FIG. 7 is a front elevation of the rework head of FIG. 6 showing a partial cutaway of a nozzle.

FIG. 8 is a perspective view of an embodiment of a nozzle with an embodiment for a quick release coupler.

FIG. 9 is a front elevation of the nozzle of FIG. 8.

FIG. 10 is a perspective view of an embodiment of a valve.

FIG. 11 is a side elevation view of the valve of FIG. 10 shown projecting into a wall of a tank.

FIG. 12 is a cross-sectional view of the valve as viewed along lines 12-12 of FIG. 11.

FIG. 13 is another embodiment of a vapor phase rework station in which the entire circuit board is disposed within the nozzle.

### DETAILED DESCRIPTION

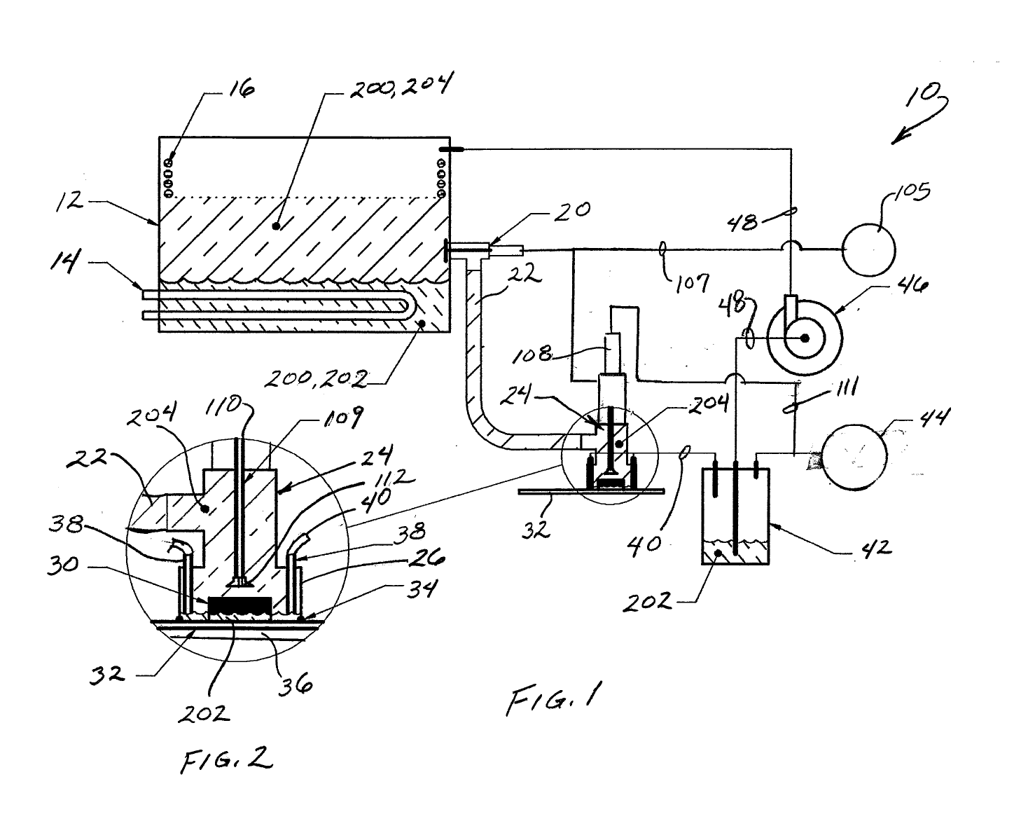

Referring now to the drawings, wherein like reference numerals designate identical or corresponding parts throughout the several views, FIG. 1 is a schematic diagram illustrating an embodiment of a rework station designated generally by reference numeral 10. In this embodiment the rework station 10 includes an enclosed tank 12 for holding a volume of an inert state changing medium 200 that will change from a liquid state 202 to a vapor state 204 at precise known temperature. There are various types of state changing mediums 200 as recognized by those skilled in the art of vapor phase reflow systems. The trademark name of one such product distributed by 3M Company is Fluorinert®. The particular properties such as boiling or vapor temperature of the state changing medium 200 is selected depending on various factors recognized by those skilled in the art, including solder properties and the type of electronic component to be removed, among other factors.

The tank 12 is elevated above the rework area for reasons that will be discussed later. Disposed within the tank 12 near its bottom is an immersion heater 14 for heating the liquid medium 202. Although not shown in the drawings, the immersion heater 14 preferably includes an on/off switch as well as a temperature setting device for selecting the desired temperature for the immersion heater 14. Cooling coils 16 are also disposed within the tank 12 near its top. A water pump (not shown) in communication with a water source pumps circulates water through the cooling coils 16. A vent port 18 (FIG. 5) is also provide in the tank 12 for ventilation and exhaust so as to avoid pressure buildup within the tank. As will be discussed in greater detail later, the immersion heater 14 heats the pool of liquid medium 202 to boiling thereby causing some of the liquid medium 202 to change its state to a vapor medium 204. As the vapor medium 204 rises within the tank 12, the cooling coils 16 disposed near the top of the tank 12 cause the vapor medium 12 to condense and drop back into the pool of boiling liquid medium 202.

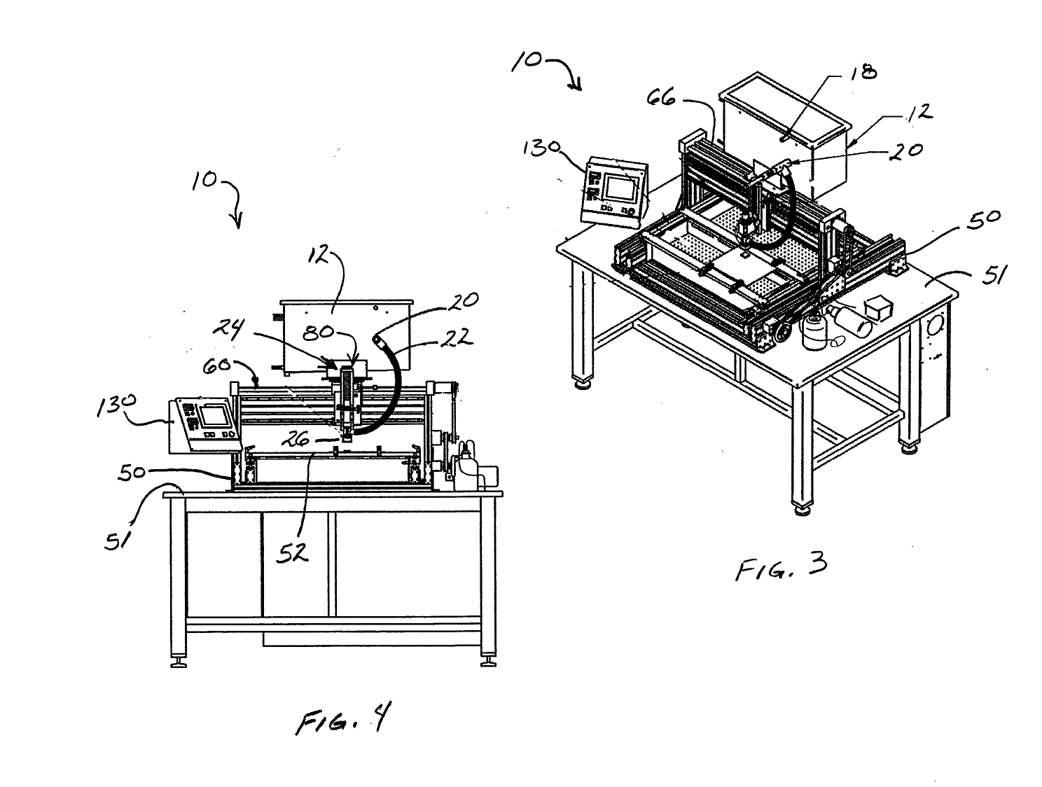

A valve 20 is disposed through the wall of the tank 12 above the pool of boiling liquid medium 202 and below the cooling coils 14. A conduit 22 connects at one end to the valve 20 and at its other end to the rework head 24. Disposed on the end of the rework head 24 is a nozzle 26. As illustrated in FIG. 2, which is an enlarged view of the rework head 24 shown in FIG. 1, the nozzle 10 is sized and shaped to receive the electronic component 30 this is desired to be removed (the “target component 30”) from the circuit board 32 as will be discussed in more detail later. Because the vapor medium 204 within the tank 12 is heavier than air, upon opening the valve 20, the vapor medium 204 will travel downward through the conduit 22 by gravity flow to the rework head 24 and into the nozzle 26 that is disposed over the target component 30. As the vapor medium 204 envelopes the target component 30 enclosed by the nozzle 26, the vapor medium 204 condenses as the heat is transferred to the component 30. The vapor medium 204 and the condensing liquid medium 202 are prevented from escaping the nozzle 26 by a high temperature seal 34 extending around the base perimeter of the nozzle 26. If the area of the circuit board 32 enclosed by the perimeter of the nozzle 26 includes through holes, a high temperature bottom seal 36 is also provided to prevent the vapor 204 and any condensed liquid 202 from escaping. Sealing the area enclosed by the nozzle 26 not only serves to prevent the loss of the expensive medium 200, but it also prevents heat loss thereby improving the efficiency of the rework process, and it prevents possible injury to the operator from exposure to the high temperature vapor.

Continuing to refer to FIGS. 1 and 2, a plurality of suction tubes 38 extend into the nozzle 26 just above the circuit board 32. Suction hoses 40 connect the suction tubes 38 to a sealed liquid collection container 42. A vacuum pump 44 in communication with the liquid collection container 42 creates a negative pressure within the container 42. Thus, as the vapor medium 204 condenses within the nozzle 26, the condensed liquid medium 202 is drawn out through the suction tubes 38 and suction hoses 40 and into the liquid collection container 42 by the vacuum pump 44. The removal of the condensed liquid medium 202 prevents the undesirable accumulation of liquid around the target component 30, thereby allowing more vapor 204 to enter the nozzle 26 until temperatures have reached a steady state. A liquid pump 46 is preferably disposed to pump the collected liquid 202 from the liquid collection container 42 through a liquid return pipe 48 so as to return the liquid medium 202 back to the tank 12.

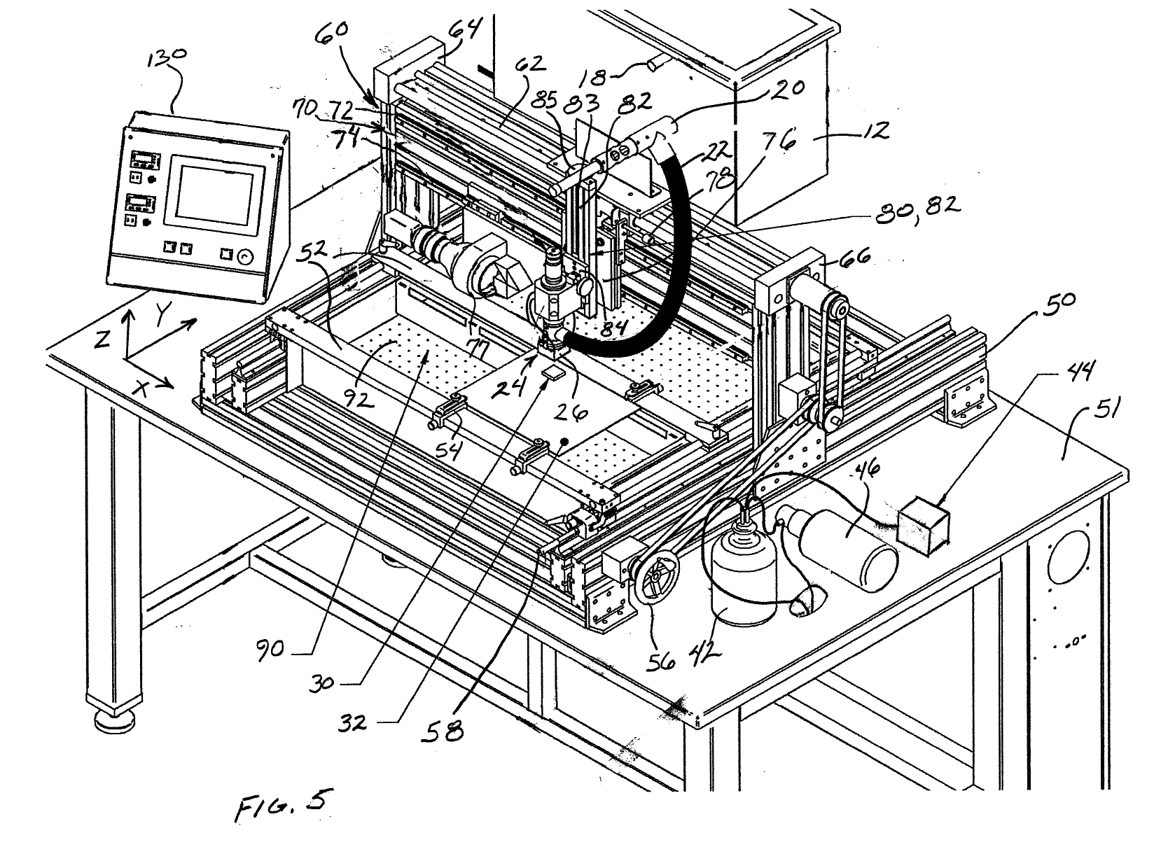

With the foregoing general description, a preferred embodiment of a rework station 10 is hereinafter described. Referring now to FIGS. 3 through 5, the rework station 10 preferably includes a support base 50. The support base 50 may be self-supporting or the support base 50 may be adapted for support on a separate table or other support surface 51. As best illustrated in FIG. 5, the support base 50 preferably supports a Y-axis positioning platform 52. The circuit board 32 having the target component 30 soldered thereto is preferably secured by movable clamps 54 to the platform 52. With the circuit board 32 secured to the platform 52, the platform 52 may be moved relative to the support base 50 in the Y-axis direction until the target component 30 is positioned substantially in line with the nozzle 26 along the Y-axis. The Y-axis movement of the platform 52 may be accomplished manually or automatically. To enable manual adjustment, the platform 52 preferably includes a Y-axis coarse adjustment mechanism 56 and a Y-axis fine adjustment mechanism 58. The Y-axis course adjustment mechanism 56 may comprise a series of belts and pulleys arranged as is well known in the art to cause the platform to move back and forth along tracks or rails (not shown) in the support base 50. The fine Y-axis adjustment mechanism 58 may comprise a rotatable threaded rod to move the platform 52 along the tracks by rotating the rod. Obviously other mechanisms may be provided for manual adjustment of the platform in the Y-axis as is well known in the art and therefore the type of adjustment mechanisms should not be construed to limit the scope of the invention.

As best illustrated in FIG. 5, an X-axis position guide 60 is also provided for positioning the rework head 24 with respect to the platform 52 in the X-axis direction. In the preferred embodiment, the X-axis position guide 60 is positioned above the support base 50 and platform 52 by a beam 62 supported at each end by vertical posts 64, 66 fixedly secured to opposing sides of the support base 50. The beam 62 also preferably supports the tank 12. The X-axis position guide 60 comprises a track 70 extending along the face of the beam 62. The track 70 comprises top and bottom rails 72, 74. Guide wheels (not visible) rotatably secured to the back side of the guide rail bracket 76 ride within the top and bottom rails 72, 74 thereby movably supporting the guide rail bracket 76 in the X-direction along the beam 62. The X-axis guide 60 may be movably positioned manually or automatically. To enable manual adjustment, the guide 60 may include a coarse adjustment mechanism (not visible) and a fine adjustment mechanism 78. The fine adjustment mechanism may comprise a rotatable threaded rod similar to the Y-axis fine adjustment mechanism 58. Obviously other mechanisms may be provided for manual adjustment of the rework head 24 in the X-axis as is well known in the art and therefore the type of adjustment mechanisms should not be construed to limit the scope of the invention.

Mirrors and/or cameras 77 (FIG. 5) may be mounted on the rework head 24 or on the beam 62 adjacent the rework head 24 to enable the operator to view the target component 30 with respect to the position of the nozzle 26 so as to accurately position the nozzle 26 over the target component 30 by adjusting the X and Y fine adjustment mechanisms.

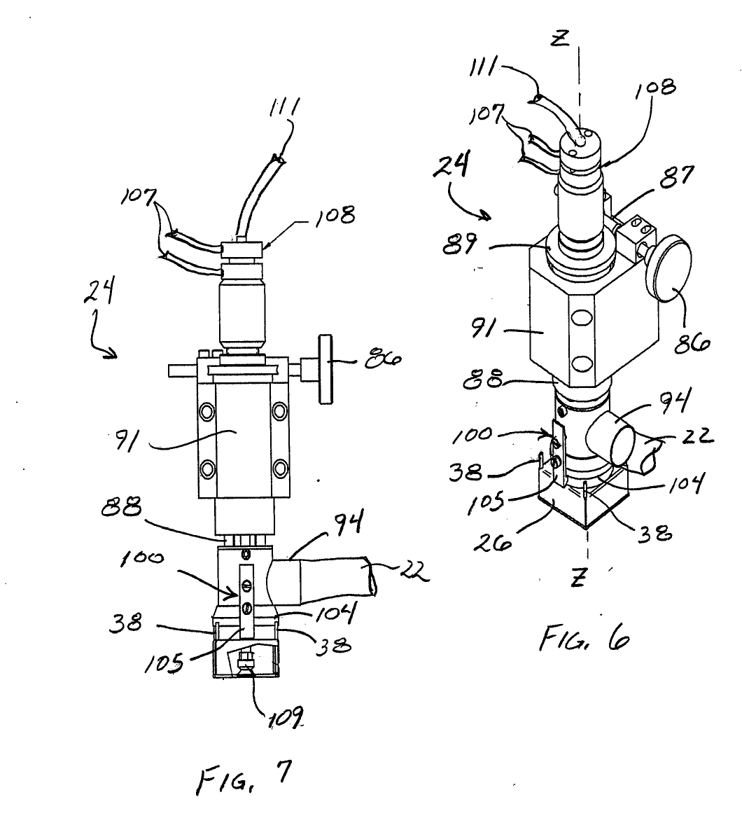

In addition to X and Y-axis positioning, a Z-axis positioning station 80 is also preferably provided as best illustrated in FIG. 5. In the preferred embodiment, the Z-axis station 80 comprises a vertically disposed slider track 82. A lead screw 83 running the length of the track and restrained at one end of the track engages threads in the slide. By rotating a Z-axis vertical adjustment knob 85 (FIG. 5), clockwise and counterclockwise the screw 83 is caused to rotate thereby moving the rework head bracket 84 and the rework head 24 mounted thereto, vertically up and down relative to the platform 52. The Z-axis positioning station 80 also preferably includes the ability to rotate the nozzle 26 about the vertical axis Z-Z (FIG. 6) of the rework head 24. Referring to FIG. 6, in a preferred embodiment, a Z-axis rotation knob 86 is connected to a worm gear 87 that engages a worm wheel 89 fixed to a rotatable shaft 88 that extends through the rework head mount 91. The rework head mount 91 mounts to the rework head bracket 84 that cooperates with the slider track 82. Thus, by turning the Z-axis rotation knob 86, the shaft 88 is caused to rotate about the Z-Z axis.

To enable automatic adjustment appropriate software and sensors may be utilized to map the circuit board 32 and to identify the position of the target component 30 with respect to the circuit board 32 and the nozzle along X, Y and Z axis. Once the circuit board 32 and the target component 30 is mapped, motors or other means of automatically moving the Y-axis platform 52, the X-axis guide 60 and the Z-axis station 80 are controlled to position the component under the nozzle 10.

Continuing to refer to FIG. 5, the support base 50 also preferably supports a preheat bed 90 for use in preheating the circuit board 32 containing the target component 30. Preheat beds are conventional and well known in the rework art. In a preferred embodiment, the preheat bed 90 comprises a perforated top plate 92 under which is disposed electric heat coils (not shown). Air flow produced by the vacuum pump 44 is preferably directed to force heated air up through the perforated plate 92 so as to provide convective heat in addition to the radiant heat from the heat coils to more efficiently heat the bottom side of the circuit board 32 positioned on the platform 52. A switch and temperature gauge is preferably provided (not shown) to control the operation of the preheat bed 90.

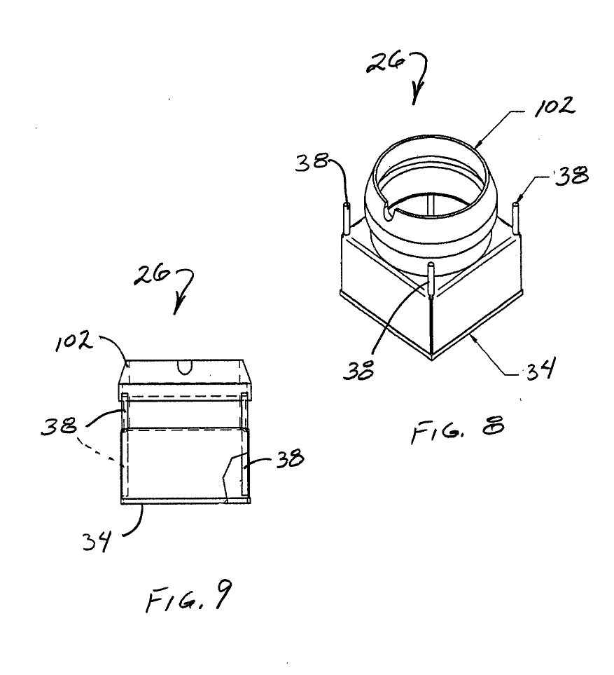

A preferred embodiment of the rework head 24 is illustrated in FIGS. 6 and 7. The rework head 24 preferably includes a stub 94 for removably receiving the end of the conduit 22. The stub 94 is preferably secured to the shaft 88 supported by the rework head mount 91. The rework head 24 also preferably includes a quick release coupler 100 for quickly changing out different nozzles 26 sized and shaped according to the target component 30 to be received therein. One example of a typical nozzle 26 adapted to cooperate with the quick release coupler 100 is illustrated in FIGS. 8 and 9. The nozzle 26 includes a collar 102 that is received within a mating collar 104 on the lower end of rework head 24. A clip 105 releasably secures the mating collars 102, 104.

Disposed above the rework head mount 91 is an actuator 108. The actuator 108 is preferably a pneumatic cylinder that is in communication with an air compressor 105 (FIG. 1) via air lines 107. The actuator 108 may be a dual-action cylinder requiring two air lines 107, one to extend the cylinder and one to withdraw the cylinder. Alternatively, the actuator 108 may be a single action, spring-loaded cylinder requiring only a single air line 107 to extend the cylinder to overcome the internal spring biasing the cylinder in a normally retracted position. Alternatively the actuator 108 may be an electric actuator or any other suitable actuator. The actuator 108 cooperates with a component gripping tool 109 (FIG. 2) having an end disposed within the interior volume of the nozzle 26. The component gripping tool 109 preferably includes a hollow shaft 110 (FIG. 2) vertically disposed in the rework head 24. The hollow shaft 110 is preferably operably in communication with the vacuum pump 44 via vacuum lines 111 and terminates at a lower end with a suction cup 112 having a through-hole so that a suction or vacuum force is provided to the suction cup 112. The purpose of the vertically movable shaft 110 terminating with a suction cup 112 is to provide a means of holding or gripping the target component 30 and lifting or withdrawing it from the board 32 as will be discussed in greater detail later. Depending on the size of the nozzle 26 and the target component 30 to be removed, a manifold with multiple suction cups may be secured to the end of the vertical shaft 110. Alternatively, rather than using vacuum or negative pressure to grip the target component(s), the component gripping tool 109 may be an electronically or mechanically actuated clamp or claw which grips the edges or sides of target component.

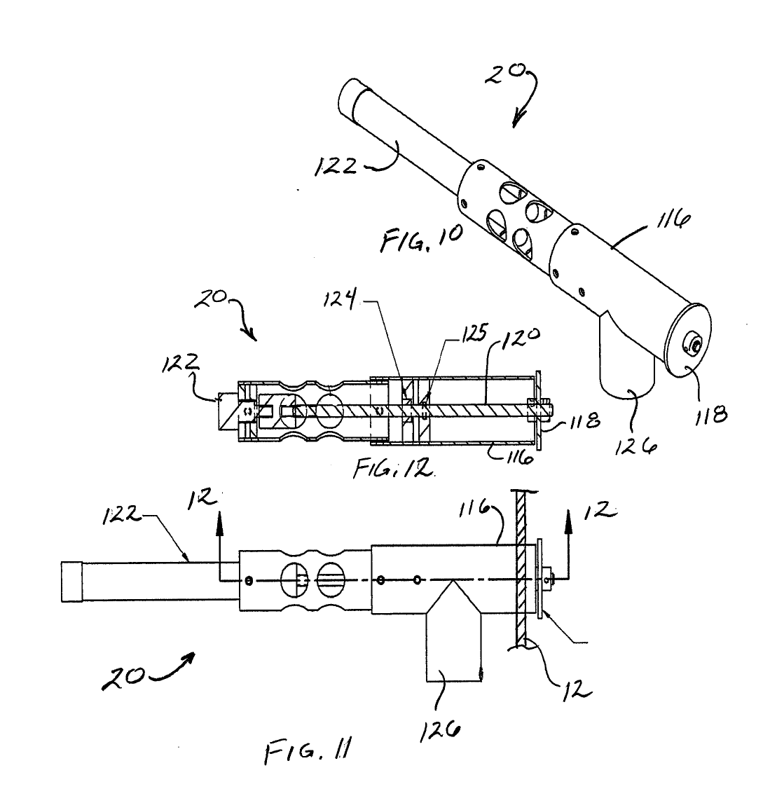

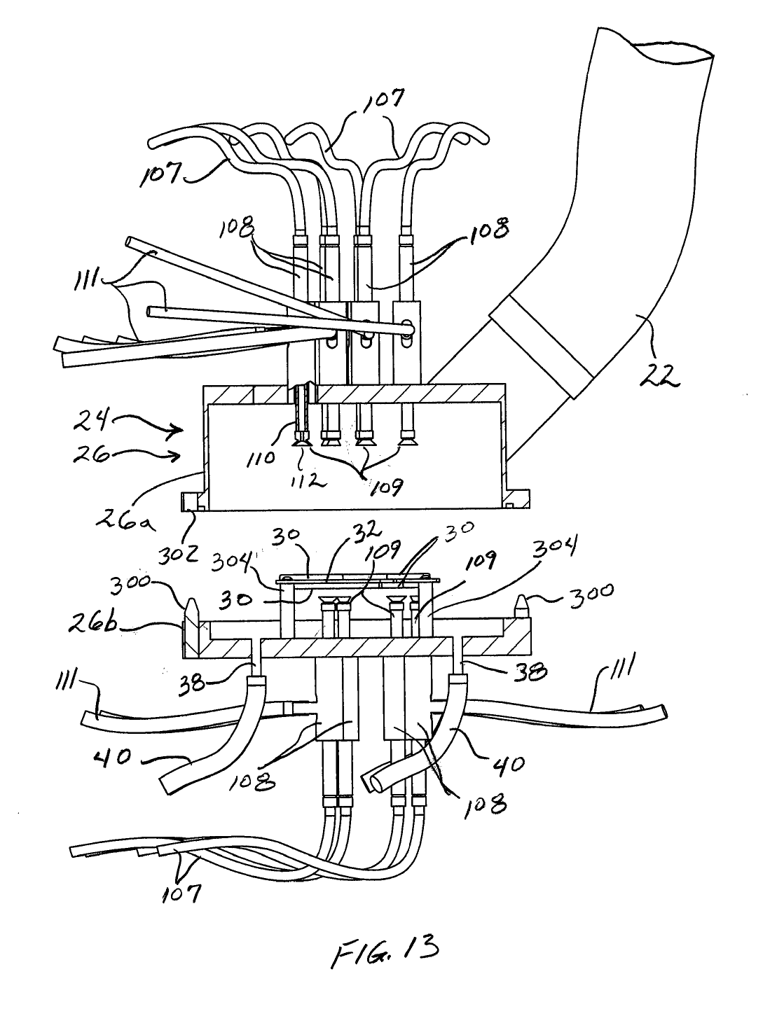

FIGS. 10 through 12 illustrate a preferred embodiment of the valve 20. The valve 20 preferably comprises a barrel 116 a portion of which projects through the wall of the tank 12. A stopper 118 is comprised of a metal disk with a high temperature seal to serve as a stopper that seals off the end of the barrel 116 that projects into the tank 12. A rod 120 (FIG. 12) extends through the barrel 116 and connects at one end to the stopper 118. The valve 20 further includes an actuator 122 that causes the rod to move in or out with respect to the barrel 116 to open and close the stopper 118. The actuator 122 may be a pneumatic actuator that is in communication with the vacuum pump 44 or compressor 105. Alternatively, the actuator 122 may be an electric actuator or any other suitable actuator. Disposed within the barrel 116 are bushings 124 (FIG. 12) and high temperature o-ring seals 125 (FIG. 12) to prevent the escape of vapor 204 from the barrel or around the rod 120. A connector 126 (FIGS. 10, 11) projects from the barrel 116 to receive one end of the conduit 22.

A computer or controller 130 may be provided to monitor and control the operation of the rework station 10. The controller 130 may include a touch screen user interface to enable the operator to operate all functions of the rework station. The controller may contain recipes for individual parameters of automatic cycle operations as well as manual controls.

It should be appreciated that depending on the size of the target component 30 to be removed, and thus the size of the nozzle 26, it may be desirable to increase the size of the tank 12 and/or to increase the number of valves 20 and conduits 22 to communicate a sufficient quantity of vapor medium 204 to the target component to improve the efficiency of the rework station.

In operation, the typical workflow sequence using the rework tool 10 may be as follows:

The rework system 10 is powered up by turning on the switch for the immersion heaters 14 and the water pump (not shown) for circulating water through the cooling coils 16. The immersion heaters 14 heat the liquid medium 202 in the tank 12 until the liquid 202 reaches a steady boil. Vapor 204 is created by the boiling liquid medium 202. The vapor medium 204 is heavier than the air within the tank 12 so a vapor envelope is created within the tank 12 between the boiling liquid 202 and the cooling coils 16. As the volume of vapor medium 204 continues to build as the liquid medium 202 continues to boil, the vapor medium 204 rises to the level of the cooling coils 16 which causes the vapor to condense and fall back into to the pool of boiling liquid 202. Thus, the volume of vapor medium 204 is maintained by the immersion heaters 14 and is contained by the cooling coils 16. Once a sufficient volume of vapor builds up in the tank, the rework process may begin.

With the nozzle 26 of the rework head 24 in the raised position, the operator places the circuit board 32 to be reworked onto the Y-axis positioning platform 52 and secures the circuit board 32 in place with the holding clamps 54. The operator aligns the target component 30 to be removed from the circuit board 32 with the nozzle 26 by moving the platform 54 in the Y-axis direction and the rework head 24 along the X-axis direction by the X-axis positioning guide 60 until the target component 30 is roughly positioned under the nozzle 26. The rework head 24 is lowered by adjusting the Z-axis station 80 and fine adjustments are made in the X-Y direction by adjusting the appropriate fine adjustment mechanism until the target component 30 is precisely positioned and is able to be received within the nozzle 26.

The nozzle 26 is then lowered over the target component 30 by rotating the Z-axis vertical adjustment knob 85 until the seal 34 around the base perimeter of the nozzle 26 presses against the surface of the circuit board 32 to form a liquid tight seal. If any rotation of the nozzle 26 with respect to the target component 30 is necessary, the Z-axis rotation knob 86 may be turned to rotate the nozzle 26 as needed. If there are any through-holes in the circuit board 32 in the area under the nozzle 26 that would allow liquid or vapor to escape, a high temperature bottom seal 36 may be disposed under the circuit board 32. If desired, the bottom seal 36 may include an electric heater element to aid in the preheating process, discussed later.

The vacuum pump 44 is now turned on. The vacuum pump 44 is also preferably in communication via tubing to the shaft 110 (FIG. 2) that extends vertically down into the nozzle 10. The actuator 108 (FIG. 6) is then actuated to cause the shaft 110 to be lowered or extended so that the component gripping tool 109 grips the target component, for example, in the preferred embodiment, the suction cup 112 on the bottom end of the shaft 110 contacts and grips the target component 30.

The circuit board 32 is preferably preheated such that the entire board or at least the portion disposed over the preheat bed 90 is slowly brought up to a predetermined temperature below the solder reflow or melting point. Once the circuit board 32 has been sufficiently preheated, the reflow step begins by opening the valve 20 in the side of the vapor tank 12. The vapor medium 204, being many times heavier than air, flows by gravity down the conduit 22 to the rework head 24 and into the nozzle 26 previously positioned over the target component 30. The vapor medium 204, being at a higher temperature than the surfaces enclosed within the nozzle 10, condenses onto those surfaces, releasing its latent heat of vaporization to those surfaces. All the surfaces, including the nozzle 26, circuit board 32 and the target component 30 are quickly and uniformly heated to a point above the reflow, or melting, point of the solder, this specific temperature being determined by the boiling point of the medium 200.

When the vapor 204 condenses back to a liquid 202, the liquid 202 runs down the surfaces to the lowest point enclosed by the nozzle 26, which is the surface of the circuit board 32. To prevent the liquid from accumulating on the board and filling up the nozzle 26 and to prevent the liquid from creating an insulating barrier on the parts and to allow more vapor into the nozzle 26, the liquid is removed through the vacuum tubes 38 in communication with the vacuum pump 44. The vacuum tubes 38 are preferably positioned within the nozzle to ensure the condensed liquid is uniformly removed. The vacuum tubes 38 also preferably extending into the nozzle 26 terminating just above the board 32. The amount of vacuum and number of vacuum tubes positioned within the nozzle 26 are preferably sufficient to draw the condensed liquid 202 out of the nozzle 26 and into the liquid collection container 42 as quickly as the liquid is created, so as to keep the nozzle free of excess liquid.

To reduce the temperature of the condensed liquid 202 being removed from the nozzle 26 to a safer handling temperature, and also to condense out any vapor 204 that may also be vacuumed out of the nozzle along with the liquid 202, a heat exchanger may be connected to the hose 40 to further cool the liquid before it is collected in the collection container 42. From the collection container 42, the liquid 202 is preferably continuously returned to the tank 12 by the liquid pump 46. The liquid pump 46 is preferably actuated at the same time as the valve 20 is opened.

After the target component 30 has reached the desired temperature above the solder reflow point, and after waiting a period of time for a margin of safety, the actuator 108 (FIG. 6) is again actuated to raise or retract the shaft 110 and with it, the component target component 30 gripped by the gripping tool 109 is raised or withdrawn from the surface of the board 32. Upon removal of the target component 30, the valve 20 is closed. The vacuum pump 44 continues to run for a sufficient length of time so that any liquid 202 remaining in the nozzle 26 is suctioned through the tubes 38 and hoses 40 into the collection container 42. Additionally, the continued operation of the vacuum pump 44 allows the condensed liquid to return again to vapor due to the heat still trapped within the nozzle 26 that remains sealed to the board 32. In this way, when the nozzle 26 is eventually raised, the parts are dry and very little if any heat transfer medium is lost. After a sufficient period of time, generally no more than a few more seconds after closing the valve 20, the nozzle 26 is then raised and along with it, the target component 30 gripped by the component gripping tool 109.

With the valve 20 closed preventing the vapor 204 from flowing down the conduit 22, the target component 30 quickly cools to the point where the molten solder re-solidifies. The board also cools such that it may be handled for further work. Cooling may be accelerated by turning on a fan, directed at the rework area.

With the rework heat cycle now complete, the operator deactivates the vacuum pump 44 and the removed target component 30 is released from the component gripping tool 109. If the removed target component 30 is to be replaced with another component, the circuit board 32 is prepared by cleaning the surface and applying fresh solder paste to the site where the new component will be placed. The vacuum pump 44 is again turned on and the new component is placed for gripping by the component gripping tool 109, for example, onto the suction cup 112. The new component is then aligned vertically over the newly prepared circuit board site by eye or by using the mirrors and/or camera 77 preferably with split image optics to display with magnification, the images of the board and component on the monitor of the controller 130. When alignment is correct, the nozzle 26, with new component, is lowered down to the board surface, sealing against it once again. The new component is then released by the gripping tool 109 and the actuator 108 raises the shaft 110 and gripping tool 109 away from the new component. The reflow heat cycle is then repeated. This time, however, the solder paste is reflowed to attach the good, new component to the circuit board 32 to complete the repair and rework of the circuit board.

FIG. 13 illustrates an alternative embodiment, wherein the circuit board 32 includes multiple target components 30 on both an upper and lower surface of the circuit board 32 that are desired to be removed and replaced. Accordingly, in this embodiment the rework head 24 comprises a nozzle 26 with mating upper and lower nozzle sections 26a, 26b, which, when brought into mating alignment, define an interior volume. The Y-axis positioning platform 52, the X-axis positioning guide 60, and Z-axis positioning station 80 may be used to align the upper and lower nozzle section 26a, 26b. Alignment a pins 300 and mating apertures 302 are preferably provided around the periphery of the upper and lower nozzle sections 26a, 26b to assist in the alignment and seating of the two nozzle sections. As in the previous embodiment, the conduit 22 communicates the vapor 204 to the rework head 24 and nozzle 26. Spacers 304 support the circuit board 32 above the bottom nozzle section 26b. Vacuum or suction tubes 38 extend into the bottom of the bottom nozzle section 26b. As in the previous embodiment, the actuators 108 are provided to extend the component gripping tools 109 toward and to grip the target components 30.

In operation, as described with the other embodiments, in the previous embodiment, the vapor medium 204 preferably flows by gravity down the conduit 22 to the rework head 24 and into the nozzle 26. The vapor medium 204, being at a higher temperature than the surfaces enclosed within the nozzle 10, condenses onto those surfaces, releasing its latent heat of vaporization to those surfaces. All the surfaces, are quickly and uniformly heated to a point above the reflow, or melting, point of the solder, this specific temperature being determined by the boiling point of the medium 200.

When the vapor 204 condenses back to a liquid 202, the liquid 202 runs down the surfaces to the lowest point enclosed by the nozzle 26. To prevent the liquid from accumulating within the interior volume of the nozzle, and to prevent the liquid from creating an insulating barrier on the parts and to allow more vapor into the nozzle 26, the liquid is removed through the vacuum tubes 38 in communication with the vacuum pump 44. The vacuum tubes 38 are preferably positioned within the nozzle to ensure the condensed liquid is uniformly removed. The amount of vacuum and number of vacuum tubes positioned within the nozzle 26 are preferably sufficient to draw the condensed liquid 202 out of the nozzle 26 and into the liquid collection container 42 as quickly as the liquid is created, so as to keep the nozzle free of excess liquid.

As previously described, to reduce the temperature of the condensed liquid 202 being removed from the nozzle 26 to a safer handling temperature, and also to condense out any vapor 204 that may also be vacuumed out of the nozzle along with the liquid 202, a heat exchanger may be connected to the hose 40 to further cool the liquid before it is collected in the collection container 42. From the collection container 42, the liquid 202 is preferably continuously returned to the tank 12 by the liquid pump 46. The liquid pump 46 is preferably actuated at the same time as the valve 20 is opened.

After the target component 30 has reached the desired temperature above the solder reflow point, and after waiting a period of time for a margin of safety, the actuator 108 is again actuated, to withdraw the extended shaft 110 and component gripping tool 109 gripping the target component 30. Upon withdrawal of the target component 30 from the circuit board 32, the valve 20 is closed. The vacuum pump 44 continues to run for a sufficient length of time so that any liquid 202 remaining in the nozzle 26 is suctioned through the tubes 38 and hoses 40 into the collection container 42. Additionally, the continued operation of the vacuum pump 44 allows the condensed liquid 202 to return again to vapor 204 due to the heat still trapped within the nozzle 26. In this way, when the top nozzle section 26a is lifted from the bottom nozzle section 26b, the parts are dry and very little if any heat transfer medium is lost. After a sufficient period of time, generally no more than a few more seconds after closing the valve 20, the top nozzle section 26a is lifted from the lower nozzle section 26b, exposing the circuit board 32 disposed therein with the target components gripped by the component gripping tool 109.

With the valve 20 closed preventing the vapor 204 from flowing down the conduit 22, the target components 30 quickly cool to the point where the molten solder re-solidifies. The board also cools such that it may be handled for further work. Cooling may be accelerated by turning on a fan, directed at the rework area.

With the rework heat cycle now complete, the operator deactivates the vacuum pump 44, releasing the removed target components 30. If the removed target components 30 are to be replaced with another component, the circuit board 32 is prepared by cleaning the surface and applying fresh solder paste to the site where the new component will be placed. The vacuum pump 44 is again turned on and new components are placed for gripping by the component gripping tool 109. The new components are then aligned vertically over the newly prepared circuit board site by eye or by using the mirrors and/or camera 77 preferably with split image optics to display with magnification, the images of the board and component on the monitor of the controller 130. When alignment is correct, the nozzle sections 26a, 26b are again preferably sealing seated onto each other. The new components are released by the component gripping tools 109 and the reflow heat cycle is then repeated. This time, however, the solder paste is reflowed to attach the good, new component to the circuit board 32 to complete the repair and rework of the circuit board.

The foregoing description is presented to enable one of ordinary skill in the art to make and use the invention and is provided in the context of a patent application and its requirements. Various modifications to the preferred embodiment of the apparatus, and the general principles and features of the system and methods described herein will be readily apparent to those of skill in the art. Thus, the present invention is not to be limited to the embodiments of the apparatus, system and methods described above and illustrated in the drawing figures, but is to be accorded the widest scope consistent with the spirit and scope of the appended claims.

1. A method of reworking a circuit board to remove a target component, said method comprising:
providing a circuit board with a target component soldered thereon that is desired to be removed;
disposing a nozzle over said target component, said nozzle having an interior volume;
communicating vapor from a vapor source to said interior volume of said nozzle wherein said vapor heats the solder holding said target component to said circuit board, said vapor condensing within said interior volume as the solder is heated;
removing said condensed vapor from said interior volume of said nozzle;
gripping said target component with a component gripping tool within said interior volume and withdrawing said target component from said circuit board.

2. The method of claim 1 wherein removing said condensed vapor includes suctioning said condensed vapor from said interior volume of said nozzle.

3. The method of claim 1 where said vapor is communicated by gravity to said interior volume of said nozzle.

4. The method of claim 1 further including returning said removed condensed vapor to said vapor source.

5. The method of claim 1 wherein said vapor source comprises a tank elevated above said nozzle within which is disposed a volume of state changing medium.

6. The method of claim 5 further comprising heating said state changing medium to produce said vapor.

7. The method of claim 6 further comprising producing a vapor envelope within said tank defined by cooling coils disposed within said tank a distance above said volume of state changing medium, said vapor envelope in communication with said conduit.

8. The method of claim 1 wherein said component gripping tool comprises a hollow shaft terminating with a suction cup having a hole therethrough, said hollow shaft and in communication with said vacuum source.

9. The method of claim 1 further comprising:
removing said withdrawn target component from said component gripping tool; and
gripping a new component with said component gripping tool.

10. The method of claim 9 further comprising:
disposing said gripped new component over an area of said circuit board from which said target component was previously removed;
disposing said nozzle over said area;
releasing said new component from said component gripping tool;
communicating vapor from said vapor source to said interior volume of said nozzle wherein said vapor heats newly applied solder past applied to said area, said vapor condensing within said interior volume as said newly applied solder is heated;
removing said condensed vapor from said interior volume of said nozzle;
withdrawing said nozzle from said circuit board.

11. The method of claim 1 wherein said nozzle comprises first and second nozzle sections defining said interior volume.

12. The method of claim 1 wherein said step of disposing said nozzle over said target component includes extending said nozzle over said entire circuit board.

13. The method of claim 11 wherein said step of disposing said nozzle over said target component includes extending said nozzle over said entire circuit board.
